(19) United States
(12) Patent Application Publication
(10) Pub. No.: US 2004/0164859 A1
(43) Pub. Date: Aug. 26, 2004

(54) Wireless network for detection of hazardous materials

(76) Inventor: Michael La Spisa, Paramus, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/372,737

(22) Filed: Feb. 24, 2003

(51) Int. Cl. G08B 23/00

(52) U.S. Cl. 340/539.26

(57) ABSTRACT

A method for communicating the detection of hazardous materials, such as a radioactive substance. The method includes detecting at least one hazardous material. This step may be realized using a detector positioned with a wireless unit, for example. Thereafter, at least one wireless unit transmits a notification message in response to detecting hazardous material. The notification message is then received by at least one processing center. The geo-location of the wireless unit and the source of the notification message are subsequently calculated so that the processing center may track the hazardous material, in the event it is mobile.

### BACKGROUND OF THE INVENTION

I. Field of the Invention

The present invention relates to the detection of hazardous materials, including radioactive substances and contraband.

II. Description of the Related Art

The events of Sep. 11, 2001, have challenged industry to develop innovative solutions for preventing future terrorist threats to homeland security. One threat defined has been the unlawful transportation and usage of hazardous materials. For the purposes of the present disclosure, hazardous materials include radioactive substances and contraband, for example.

Devices for detecting hazardous materials have become increasingly prevalent, as their cost of manufacture have continued to drop. One such device for detecting hazardous material is a radiation detector, which is known to have several applications. For example, radiation detectors have been employed in nondestructive inspection of objects, including contraband. Here, the object for inspection is bombarded with energetic radiation, such as gamma-, x-ray, and/or neutron radiation, for example. A point source generates the radiation, which penetrates the object. Thereafter, an image may be derived through the use of a radiation detector, which detects and records the radiation transmitted through object. Thereafter, the radiation detector converts the energy carried by the penetrating particles, or quanta, into visible light, which is recorded to create a suitable image of the object.

Radiation detectors may be realized by any one of a number of technologies. One traditional approach involves the use of an expensive and hefty Geiger counter. Alternatively, radiation detectors may be realized using a crystal-based scintillator and a photo-detector (e.g., photo-multipliers). Yet still another approach involves the use a sensor semiconductor device, such as a gallium arsenide diode, to detect radioactive particles.

To effectively prevent the transportation of hazardous material, continuous detection is necessary. Furthermore, the granularity in detection corresponds with the number of detectors employed. Accordingly, a greater number of detectors may be needed over a wide landmass.

### SUMMARY OF THE INVENTION

The present invention provides for the systematic detection of hazardous materials, including radioactive substances and contraband. The present invention may utilize wireless communications infrastructure elements, including a fixed and/or mobile wireless unit(s), a base station(s), and a base station controller(s), for example, to monitor and detect hazardous materials. By relying on existing infrastructure elements, the present invention provides a method for accurately detecting and monitoring hazardous materials over a wide landmass in a coordinated manner.

In one embodiment of the present invention, the system passively detects hazardous materials through individual wireless units. Here, one or more wireless unit transmits a notification message acknowledging the detection of hazardous materials. The notification message may be transmitted over an allocated wireless emergency channel. The notification message may include additional information such as geo-location data, as well as an identified quantity level(s) of the hazardous material(s). The notification message may be received by a processing center or switch for tracking the hazardous materials and alerting an emergency agency.

In another embodiment of the present invention, the system actively detects hazardous materials through a processing center through individual fixed and/or mobile wireless units. In this scenario, one or more wireless units may transmit a notification message acknowledging the detection of hazardous materials to processing center. The transmission of the notification message may be executed over an allocated wireless emergency channel, for example. Using geo-location data and identified quantity level(s) of the hazardous material(s), the processing center may, in response, direct other wireless units in the area to track the movement of detected hazardous materials while also alerting the appropriate emergency agency.

### BRIEF DESCRIPTION OF THE DRAWINGS

The present invention will be better understood from reading the following description of non-limiting embodiments, with reference to the attached drawings, wherein below:

FIG. 1 depicts a first embodiment of the present invention;

FIG. 2 depicts another embodiment of the present invention; and

FIG. 3 depicts yet another embodiment of the present invention.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

The present invention provides for the systematic detection of hazardous materials. For the purposes of the present disclosure, hazardous material includes radioactive substances, such as fissionable matter, chemical/biological substances, and contraband, for example. More particularly, the present invention may utilize wireless communications infrastructure elements, including fixed wireless handset units, mobile handset units, base stations, and base stations controllers, for example, to monitor and detect hazardous materials. By relying on existing infrastructure elements, the present invention provides a method for accurately detecting and monitoring hazardous materials over a wide landmass in a coordinated manner.

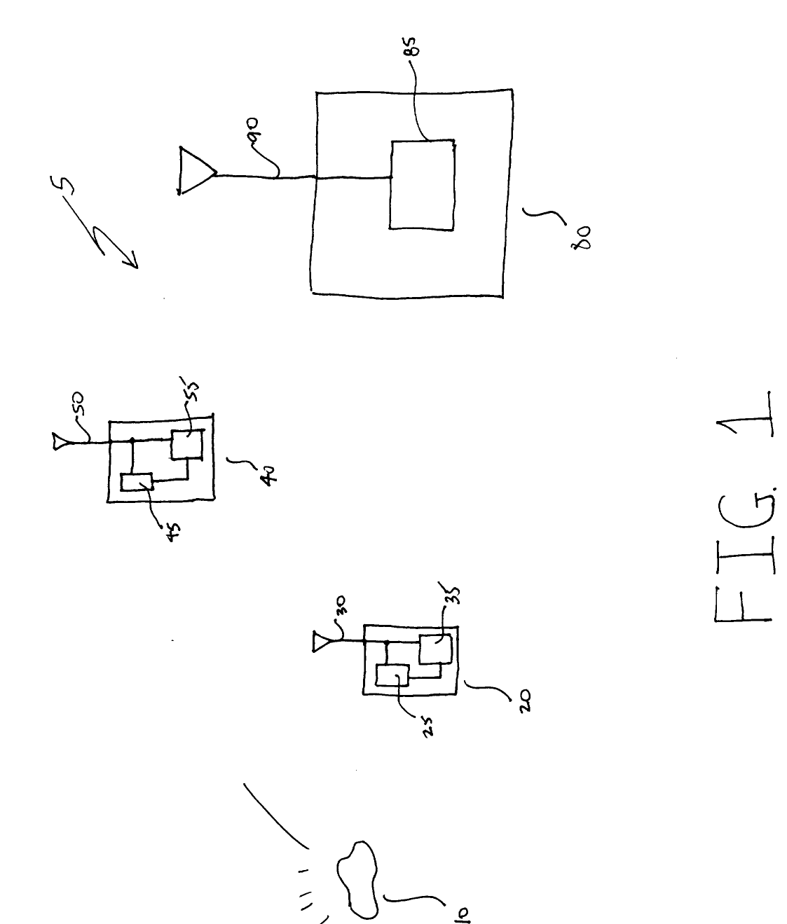

Referring to FIG. 1, a system 5 for detecting hazardous materials, such as illustrated substance 10, is shown in accordance with the principles of the present invention. System 5 comprises at least one wireless unit realized, for example, by a fixed and/or mobile wireless handset. As an exemplary illustration, a first and second wireless handset, 20 and 40, are depicted as part of system 5.

First and second wireless handsets, 20 and 40, each respectively comprise at least one detecting device, 25 and 45, therein for detecting hazardous materials. Detecting devices, 25 and 45, may be realized by any number of sensor elements. For example, detecting devices, 25 and 45, may comprise a sensor-type semiconductor, such as a gallium arsenide diode, for detecting radioactive particles. Each handset processing unit, 35 and 55, is coupled with a respective antenna, 30 and 50, to support the transmission of a notification message in the event hazardous material 10 is detected.

Furthermore, first and second wireless handsets, 20 and 40, each respectively comprises a handset processing unit, 35 and 55. Each handset processing unit, 35 and 55, perform various traditional wireless handset functions. As shown, each handset processing unit, 35 and 55, is coupled with a respective antenna, 30 and 50. Moreover, each handset processing unit, 35 and 55, is, in turn, coupled with a respective detecting device, 25 and 45, for supporting the transmission of a notification message in the event hazardous material 10 is detected.

System 5 also comprises a central network node 80. Central network node 80 may comprise a base station and/or base station controller. Central network node 80 receives a notification message transmitted by one of wireless handsets, 20 and 40. The transmitted notification message enables system 5 to detect, locate, monitor and/or track hazardous material 10.

Central network node 80 may act has the nerve center to detect, locate, monitor and/or track hazardous material 10. Information from the notification message may be stored in a central database, where it may be analyzed and processed. Moreover, the information from the notification message may be displayed showing the map with a topology based on the detected levels of the relevant geographical area. Any movement in the detected hazardous material 10 may also be similarly displayed.

In an alternative embodiment, central network node 80 also comprises a detecting device (not shown) for detecting hazardous materials. Central network node 80, consequently, may generate a notification message. This notification message may be transmitted to one of the handset processing units, 35 and 55, for enabling the direct detecting, monitoring and tracking of hazardous material 10. Furthermore, notification message may be transmitted by central network node 80 to higher-level network node for managing the information regarding hazardous material 10.

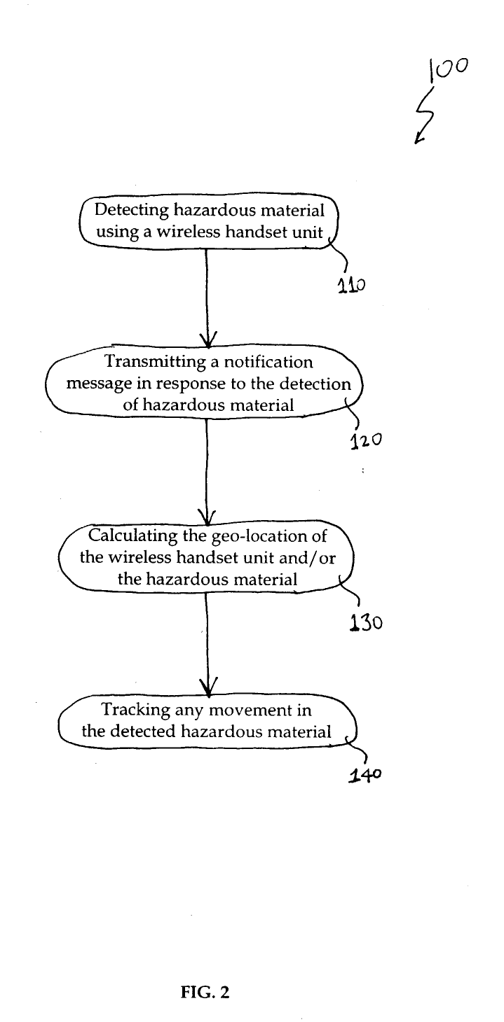

Referring to FIG. 2, a flow chart depicting an embodiment of the present invention is illustrated. More particularly, a method (100) is shown for detecting hazardous materials. Here, one or more hazardous materials are detected (110). This method step may be performed by a fixed and/or mobile wireless handset.

Thereafter, a notification message is transmitted (120). This transmitting step is executed in response to the detection of one or more hazardous materials. The notification message should identify the detected hazardous material as being a radioactive substance, a chemical substance, a biological substance and/or contraband. This transmitting step may be performed by the fixed and/or mobile wireless handset such that the notification message is broadcast over a wireless emergency channel. Alternatively, the notification message may be transmitted within a typical communication protocol. Given the potentially timely and sensitive nature of the detection of hazardous material, however, the notification message may be transmitted using one of a number of prioritization schemes over other voice and data traffic.

The whereabouts of the wireless handset unit transmitting the notification message may be of significant importance in the monitoring and/or tracking of the detected hazardous material. Consequently, the method (100) also includes the step of calculating the geo-location of the wireless handset unit (130). The step of calculating the geo-location, in the alternative, may also include determining the geo-location of the hazardous material (130). If possible, however, the notification message may already include geo-location data of the wireless handset unit and/or the hazardous material(s), detected quality levels of the hazardous material(s), as well as the time the hazardous material was detected by the wireless handset unit. With the geo-location of the wireless handset unit and/or the hazardous material determined, any movement to the detected hazardous material might be tracked (140).

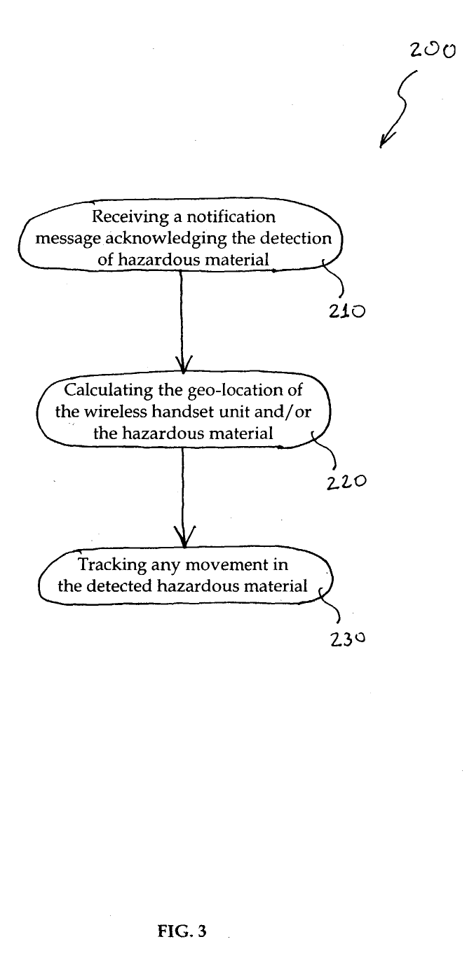

Referring to FIG. 3, a flow chart depicting an embodiment of the present invention is illustrated. More particularly, a method (200) is shown for detecting hazardous materials. Here, a notification message is received (210). As detailed hereinabove, the notification message may be transmitted by a wireless handset unit, for example. Correspondingly, the notification message may be received by a processing center, such as a base station, base station controller, and/or network node, for example.

The notification message may identify one or more hazardous materials that have been detected by at least one wireless handset unit. For example, the wireless handset unit may detect a radioactive substance, a chemical substance, a biological substance and/or contraband, and, in response, transmit the notification message. The notification message may be transmitted, and thusly, received over a wireless emergency channel. Alternatively, the notification message may be received within a typical communication protocol. Given the potentially timely and sensitive nature of the detection of hazardous material, however, the notification message may be received using one of a number of prioritization schemes over other voice and data traffic.

In the monitoring and/or tracking of the detected hazardous material, the geo-location of the detected material may be of significant importance. As a result, the method (200) also includes the step of calculating the geo-location of the wireless handset unit (220). In this case, the transmission point from which the notification message was transmitted may be calculated. In the alternative, the step of calculating may also include determining the geo-location of the hazardous material (220).

If possible, however, the notification message may already include geo-location data of the wireless handset unit and/or the hazardous material(s), detected quality levels of the hazardous material(s), as well as the time the hazardous material was detected by the wireless handset unit. With the geo-location of the wireless handset unit and/or the hazardous material determined, any movement to the detected hazardous material might be tracked (230).

Once the hazardous material has been identified and its geo-location calculated, the processing center might continue to track the detected hazardous material whereabouts. This may be realized by passively awaiting other wireless units to detect the presence of the identified hazardous material. Alternatively, the processing center may actively broadcast a control message to wireless units identified within proximity of the geo-location of initial wireless handset and/or the hazardous material. In so doing, the processing center may continue to monitor the hazardous material. The broadcast of this type of control message may, as stated hereinabove, employ a wireless emergency channel. Alternatively, the broadcast control message may be transmitted within a typical communication protocol, though the timely and sensitive nature of the information may alternatively cause the processing center to employ one of a number of prioritization schemes over other voice and data traffic.

In response to receiving the broadcast control message, the detecting device within another wireless handset in proximity to the first wireless handset and/or the hazardous material may be triggered. This trigger may cause the detecting device to increase its sensitivity. By receiving this broadcast control message, this another wireless handset should detect and transmit another notification message corresponding with the hazardous material.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. It is therefore contemplated that the appended claims will cover any such modifications or embodiments as fall within the true scope of the invention.

1. A method of wireless communication comprising:
detecting at least one hazardous material; and
transmitting a notification message from at least one wireless unit in response to the step of detecting at least one hazardous material.

2. The method of claim 1, wherein the step of detecting is performed by a detector positioned within the wireless unit.

3. The method of claim 1, wherein the notification message identifies the detected hazardous material as comprising at least one of a radioactive substance, a chemical substance, a biological substance and contraband.

4. The method of claim 1, wherein the notification message is transmitted over a wireless emergency channel.

5. The method of claim 1, wherein the notification message is transmitted within a communication protocol.

6. The method of claim 1, wherein the notification message is transmitted using a prioritization scheme over other traffic.

7. The method of claim 1, wherein the notification message comprises at least one of geo-location data, a detected quantity of the hazardous material, a location of the hazardous material, and the time of the hazardous material was first detected.

8. The method of claim 7, further comprising the step:
calculating the geo-location data of the wireless unit.

9. The method of claim 7, further comprising the step:
calculating the location of the detected hazardous material.

10. The method of claim 1, further comprising the step:
tracking the detected hazardous material.

11. A method of wireless communication comprising:
receiving a notification message acknowledging detection of at least one hazardous material by at least one processing center.

12. The method of claim 11, wherein the notification message is transmitted by at least one wireless unit in response to detecting at least one hazardous material.

13. The method of claim 11, wherein the notification message identifies the at least one detected hazardous material as comprising at least one of a radioactive substance, a chemical substance, a biological substance and contraband.

14. The method of claim 11, wherein the notification message is at least one of received over a wireless emergency channel and received within a communication protocol.

15. The method of claim 11, wherein the notification message is received using a prioritization scheme over other traffic.

16. The method of claim 11, wherein the notification message comprises at least one of geo-location data, a detected quantity of the hazardous material, a location of the hazardous material, and the time of the hazardous material was first detected.

17. The method of claim 11, further comprising at least one of:
calculating geo-location data of a transmission point for the notification message; and
calculating location data of the detected hazardous material.

18. The method of claim 11, further comprising the step:
tracking the detected hazardous material.

19. The method of claim 18, wherein the step of tracking the detected hazardous material comprises:
broadcasting a control message in the proximity of the transmission point of the notification message.

20. The method of claim 19, wherein the step of tracking further comprises:
receiving at least another notification message in the proximity of the transmission point of the notification message.
